(19) United States
(12) Patent Application Publication
(10) Pub. No.: US 2026/0161940 A1
(43) Pub. Date: Jun. 11, 2026

(54) ACTIVATION FUNCTION PATTERN-BASED GRADIENT COMPRESSION METHOD AND SYSTEM

(71) Applicant: Samsung Electronics Co., Ltd., Suwon-si (KR)

(72) Inventors: Sang Woo PARK, Suwon-si (KR); Jae Min KIM, Suwon-si (KR)

(73) Assignee: Samsung Electronics Co., Ltd., Suwon-si (KR)

(21) Appl. No.: 19/275,400

(22) Filed: Jul. 21, 2025

(30) Foreign Application Priority Data
Dec. 11, 2024 (KR) 10-2024-0183567

(51) Int. Cl. G06N 3/08

(52) U.S. Cl. CPC G06N 3/08

(57) ABSTRACT

A gradient compression method performed by a computing device is provided. The gradient compression method may comprise: performing a computation on input data for a first node of a first model using an activation function; calculating a first gradient of a first weight corresponding to the first node based on a result of the computation; determining whether the first node is in an active state based on the result of the computation; updating the first weight based on the first gradient if the first node is in the active state; and accumulating the first gradient as an accumulated gradient for the first node if the first node is not in the active state.

### CROSS-REFERENCE TO RELATED APPLICATION

This application claims priority from Korean Patent Application No. 10-2024-0183567 filed on Dec. 11, 2024 in the Korean Intellectual Property Office, and all the benefits accruing therefrom under 35 U.S.C. 119, the contents of which in its entirety are herein incorporated by reference.

### BACKGROUND

Some example embodiments relate, in general, to an activation function pattern-based gradient compression method and/or system, and more specifically, to a method for reducing communication overhead by accumulating the gradients of weights corresponding to inactive nodes during the training of a neural network model.

In a large-scale training environment for a neural network model, a method is employed in which multiple distributed hardware devices calculate the gradients of weights, and a parameter server aggregates all the gradients generated by the hardware devices to train the neural network model. However, in a process of transmitting the result of the aggregation to the parameter server, significant communication overhead and memory bottlenecks occur, which can delay the training time of the neural network model.

To partially address this issue, a method has been used that reduces communication overhead by accumulating gradients whenever weights are updated, defining a threshold for the accumulated gradients in advance, and transmitting the accumulated gradients to the parameter server once the threshold is exceeded. However, this type of method requires or uses the process of finding an appropriate threshold depending on the neural network model and training data, necessitating preliminary experiments. These preliminary experiments take considerable time, making efficient training of the neural network model challenging. Accordingly, there is a desire for a gradient compression method that enables efficient training of the neural network model while reducing communication overhead between the parameter server and hardware devices, regardless of the types of the neural network model and training data.

### SUMMARY

At least one technical purpose to be achieved according to some example embodiments is to provide a method for reducing communication overhead between multiple computing devices and a server by accumulating gradients of weights corresponding to inactive nodes in a neural network model during training across the multiple computing devices and transmitting the accumulated gradients to the server when the corresponding nodes become active.

In addition, at least one technical purpose to be achieved according to some example embodiments is to provide a method for accumulating gradients by considering not only the current states, but also the previous states of nodes included in a neural network model.

The technical purposes of example embodiments are not limited to those mentioned above, and other objectives not explicitly stated will be clearly understood by those of ordinary skill in the art based on the following description.

According to some example embodiments, there is provided a gradient compression method performed by a computing device. The gradient compression method may comprise: performing a computation on input data for a first node of a first model using an activation function; calculating a first gradient of a first weight corresponding to the first node based on a result of the computation; determining whether the first node is in an active state based on the result of the computation; updating the first weight based on the first gradient in response to the first node being in the active state; and accumulating the first gradient as an accumulated gradient for the first node in response to the first node not being in the active state.

Alternatively or additionally according to some example embodiments, there is provided a gradient compression system. The system may comprise: a processor; and a memory storing instructions, wherein when executed by the processor, the instructions enable the processor to perform a computation on input data for a first node of a first model using an activation function; calculate a first gradient of a first weight corresponding to the first node based on a result of the computation; determine whether the first node is in an active state based on the result of the computation; update the first weight based on the first gradient if the first node is in the active state; and accumulate the first gradient as an accumulated gradient for the first node in response to the first node not being in the active state.

Alternatively or additionally according to some example embodiments, there is provided a non-transitory computer-readable medium storing a computer program, the computer program configured to, upon being executed by a processor, cause the system to: perform a computation on input data for a first node of a first model using an activation function; calculate a first gradient of a first weight corresponding to the first node based on a result of the computation; determine whether the first node is in an active state based on the result of the computation; update the first weight based on the first gradient in response to the first node being in the active state; and accumulate the first gradient as an accumulated gradient for the first node in response to the first node not being in the active state.

Alternatively or additionally according to some example embodiments, there is provided a server, and a plurality of computing devices configured to communicate with the server. Each of the plurality of computing devices is configured to calculate a first gradient of a first weight corresponding to the first node based on a result of a computation, determine whether the first node is in an active state based on the result of the computation, and accumulate the first gradient as an accumulated gradient for the first node in response to the first node not being in the active state.

In some example embodiments, each of the plurality of computing devices is configured to communicate a result of the accumulated gradient to the server.

In some example embodiments, at least one of the plurality of computing devices has a different operational speed than at least one other of the plurality of computing devices.

It should be noted that the effects of inventive concepts are not limited to those described above, and other effects of some example embodiments will be apparent from the following description.

### BRIEF DESCRIPTION OF THE DRAWINGS

The above and other aspects and features of inventive concepts will become more apparent by describing in detail some example embodiments thereof with reference to the attached drawings, in which:

FIG. 1 is a block diagram illustrating the configuration of an overall system according to some example embodiments;

FIG. 2 conceptually illustrates a gradient compression method according to some example embodiments;

FIG. 3 illustrates an example of performing a weight update or gradient accumulation based on the current state of each node;

FIG. 4 illustrates an example of performing a weight update or gradient accumulation based on both the previous and current states of each node;

FIG. 5 is a flowchart illustrating the gradient compression method according to some example embodiments;

FIG. 6 is a flowchart illustrating an example of the step of updating a first weight in FIG. 5;

FIG. 7 is a flowchart illustrating another example of the step of updating the first weight in FIG. 5;

FIG. 8 is a flowchart illustrating a gradient compression method according to another embodiment of inventive concepts;

FIG. 9 shows the loss and accuracy of a neural network model according to the number of iterations of training using the gradient compression methods according to some example embodiments;

FIG. 10 shows the communication overhead according to the number of iterations of training using the gradient compression methods according to some example embodiments; and

FIG. 11 is a block diagram illustrating the hardware configuration of a computing device including a neural network model, according to some example embodiments.

### DETAILED DESCRIPTION

Hereinafter, some example embodiments will be described in detail with reference to the attached drawings. Advantages and features of inventive concepts, and a method of achieving the advantages and features will become apparent with reference to embodiments described later in detail together with the accompanying drawings. However, some example embodiments are not limited to example embodiments as disclosed below, but may be implemented in various different forms. Thus, example embodiments are set forth only to make inventive concepts complete, and to completely inform the scope of inventive concepts to those of ordinary skill in the technical field to which inventive concepts belongs, and inventive concepts are only defined by the scope of the claims.

The same reference numbers in different drawings represent the same or similar elements, and as such perform similar functionality. Further, descriptions and details of well-known steps and elements are omitted for simplicity of the description. Furthermore, in the following detailed description of inventive concepts, numerous specific details are set forth in order to provide a thorough understanding of inventive concepts. However, it will be understood that inventive concepts may be practiced without these specific details. In other instances, well-known methods, procedures, components, and circuits have not been described in detail so as not to unnecessarily obscure gist of inventive concepts. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of inventive concepts as defined by the appended claims.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The terminology used herein is directed to the purpose of describing particular embodiments only and is not intended to be limiting of inventive concepts. As used herein, the singular constitutes “a” and “an” are intended to include the plural constitutes as well, unless the context clearly indicates otherwise.

Additionally, in describing the components of inventive concepts, terms such as first, second, A, B, a, and b may be used. These terms are only used to distinguish one component from another component, and the nature, sequence, order, or number of the component are not limited by the term. It should be understood that when a component is described as being “connected,” “coupled,” or “combined” to another component, the component may be directly connected, coupled, or combined to another component, still another component may be “interposed” therebetween, and thus the component may be connected, coupled, or combined to another component via the still another component.

It will be further understood that the terms “comprise”, “comprising”, “include”, and “including” as used herein specify the presence of the stated features, steps, operations, elements, and/or components, but do not preclude the presence or addition of one or more other features, steps, operations, elements, components, and/or portions thereof.

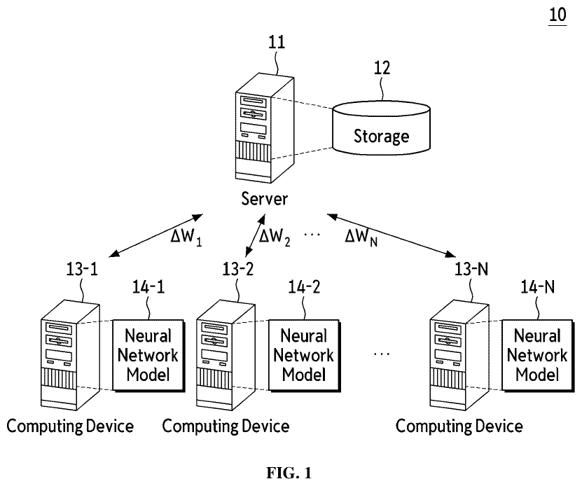

FIG. 1 is a block diagram illustrating the configuration of an overall system 10 according to some example embodiments. Referring to FIG. 1, the overall system 10 may include a server 11 and one or more computing devices 13-1, 13-2, . . . , 13-N. The server 11 may further include a storage 12, and the computing devices 13-1, 13-2, . . . , 13-N may include neural network models 14-1, 14-2, . . . , 14-N, respectively. The computing devices 13-1, 13-2, . . . , 13-N will hereinafter be collectively referred to as the computing devices 13, and the neural network models 14-1, 14-2, . . . , 14-N will hereinafter be collectively referred to as the neural network models 14.

Each of the computing devices 13-1, 13-2, . . . , 13-N may be designed to be the same, e.g., to have the same electrical and/or physical characteristics; alternatively, at least one of the computing devices 13-1, 13-2, . . . , 13-N may be different than others, e.g., may have a different one of physical and/or electrical characteristics. For example, a physical characteristic may be or may include or be based on at least one a size and/or a number of input/output ports and/or devices, and an electrical characteristic may be or may include or be based on at least one of a storage capacity, a memory capacity, a processing speed, or a power consumption; example embodiments are not limited thereto.

Each of the computing devices 13-1, 13-2, . . . , 13-N may communicate with each other and/or with the server 11, through a bus such as but not limited to a wireless bus and/or a wired bus, to exchange information such as but not limited to data and/or commands, stored in various formats such a but not limited to an analog format and/or a digital format, and may communicate to transmit and/or receive the information in various manners, such as but not limited to a broadcast manner, a one-way manner, a two-way manner, or a multiway manner; the information may be sent and/or received in various manners such as but not limited to a serial manner and/or a parallel manner. Example embodiments are not limited thereto.

The neural network models 14 may operate based on a statistical learning algorithm that is inspired by biological neurons in the fields of machine learning and cognitive science. The neural network models 14 refer to models in which artificial neurons (or nodes) forming a network through synaptic connections are capable of solving problems by adjusting the strength of the synaptic connections through learning. The neural network models 14 may each comprise a plurality of neural network layers. For example, the neural network models 14 may each include an input layer, one or more hidden layers (such as but not limited to a large number of hidden layers), and an output layer.

The plurality of neural network layers may each include at least one node and at least one weight, and may perform a neural network computation through a computation between the result of the previous layer's computation and the corresponding weight. The result of the previous layer's computation refers to input data provided to the nodes in the current layer. The computation between the result of the previous layer's computation and the corresponding weight may be performed based on one or more activation functions. For example, the activation function may be or may include or be based on one or more of a sigmoid function, tanh function, rectified linear unit (ReLU), or softmax function, but example embodiments are not limited thereto.

The weights in the plurality of neural network layers may be derived, or improved upon, or optimized or at least partially optimized based on the results of training the neural network models 14. For example, the weights may be updated during training to reduce or minimize the loss values or cost values obtained from the neural network models 14 (e.g., to reduce or minimize the gradients of the weights). The neural network models 14 may infer desired result data from arbitrary input data.

For example, the neural network models 14 may utilize at least one artificial intelligence (AI) structure and algorithm such as one or more of Convolutional Neural Network (CNN) (e.g., GoogleNet, AlexNet, or VGG Network), or Visual Analytics, Visual Understanding, Video Synthesis, and ResNet for vision processing and image classification, but example embodiments are not limited thereto. The above examples do not limit the AI structure and algorithm that can be used according to some example embodiments.

The computing devices 13-1, 13-2, . . . , 13-N may receive input data and train the neural network models 14-1, 14-2, . . . , 14-N, respectively. During training, the computing devices 13-1, 13-2, . . . , 13-N may transmit weight change values ΔW₁, ΔW₂, . . . , ΔW_{N} to the storage 12 of the server 11 whenever the weights in the neural network models 14-1, 14-2, . . . , 14-N change. The average (e.g., the mean, the median, the mode, or another measure of central tendency such as one based on at least one of the mean, the median, or the mode) of the weight change values stored in the storage 12 may be set as a new weight for the neural network models 14-1, 14-2, . . . , 14-N, and the computing devices 13-1, 13-2, . . . , 13-N may continue training the neural network models 14-1, 14-2, . . . , 14-N.

In this case, the time taken by the computing devices 13 to train the neural network models 14 corresponds to computing time, and the time taken to transmit weight change values to the server 11 corresponds to communication time. As the number of computing devices 13 increases, the number of calculated weight change values also increases, which may result in longer communication time. Consequently, communication overhead may significantly increase.

Therefore according to some example embodiments, to reduce communication overhead, the computing devices 13 may determine whether to transmit weight change values to the server 11 based on whether the nodes in the neural network models 14 are active, instead of transmitting weights to the server 11 whenever the weights change.

Specifically, the computing devices 13 may perform a computation on input data for first nodes in the neural network models 14 using an activation function. For example, the computing devices 13 may input the first nodes'input data and corresponding first weights into the activation function to execute the computation. The first weights corresponding to the first nodes refer to the weights between the first nodes and nodes connected to the first nodes in the respective previous layers. The computing devices 13 may calculate the gradients of the first weights based on the result of the computation.

Additionally or alternatively, the computing devices 13 may determine whether the first nodes are in an active state based on the computation result. If the computation result is equal to or greater than a threshold, the first nodes may be in the active state. Conversely, if the computation result is less than the threshold, the first nodes may be in an inactive state.

According to some example embodiments, if the first nodes are in the active state, the computing devices 13 may update the first weights based on the previously calculated gradients. Specifically, the update of the first weights may utilize not only the gradients calculated in the current state but also the gradients accumulated from previous states. Conversely, if the first nodes are in the inactive state, the computing devices 13 may accumulate the calculated gradients as accumulated gradients instead of immediately updating the first weights. For example, the accumulated gradients may be stored in buffers (not illustrated) of the computing devices 13.

For example, according to some example embodiments, the first weights are updated based on the gradients only when the first nodes are in the active state, and changes in the first weights are transmitted to the server 11 only when the first nodes is in the active state. Conversely, if the first nodes is in the inactive state, the gradients are accumulated, and the first weights are not updated, meaning that no weight changes are transmitted to the server 11. For example, according to some example embodiments, communication overhead occurs only when the first nodes are in the active state, and no communication overhead occurs when the first nodes are in the inactive state. This may reduce communication overhead during the training of the neural network models 14 and can lower the power consumption of the computing devices 13 and the server 11.

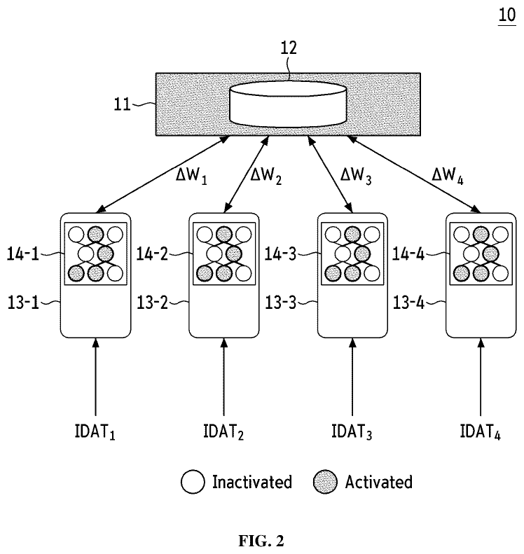

This type of gradient accumulation process may be referred to as gradient compression. Some example embodiments correspond to a gradient compression method, and the computing devices 13 may correspond to systems that perform the gradient compression method. The gradient compression method will hereinafter be conceptually reviewed with reference to FIGS. 2 through 4.

FIG. 2 conceptually illustrates a gradient compression method according to some example embodiments. FIG. 2 depicts an example overall system 10 having four computing devices 13-1 through 13-4 and neural network models 14-1 through 14-4. Input data IDAT₁ through IDAT₄ respectively corresponding to the neural network models 14-1 through 14-4 of the computing devices 13-1 through 13-4 may be input, and computations between the input data IDAT₁ through IDAT₄ and the weights for the nodes in the neural network models 14-1 through 14-4 may be performed through an activation function. Based on the results of the computations, a determination may be made as to whether the nodes in the neural network models 14-1 through 14-4 are active.

For example, in FIG. 2, active nodes are shaded in gray, and inactive nodes are unshaded (e.g., displayed in white). The gradients of weights corresponding to the shaded nodes may be immediately used for weight updates, and the gradients of weights corresponding to the unshaded nodes may continue to accumulate. Weight change values ΔW₁ through ΔW₄ in FIG. 2 may only include the gradients of the weights corresponding to the shaded nodes (e.g., the active nodes). Since the weight change values ΔW₁ through ΔW₄ only include the gradients of the weights corresponding to the active nodes, instead of including the gradients of weights corresponding to all nodes, communication overhead may be reduced.

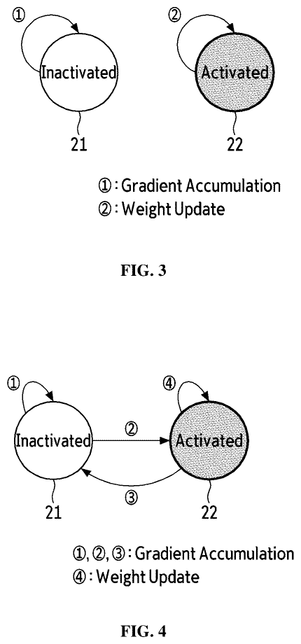

FIG. 3 illustrates an example of performing a weight update or gradient accumulation based on the current state of each node. Referring to FIG. 3, gradient accumulation may be performed (\textcircled{1}) for node 21 in the inactive state, and a gradient-based weight update may be performed (\textcircled{2}) for node 22 in the active state. For example, example embodiments illustrated in FIG. 3 corresponds to features that considers only the current state of each node. However, since nodes that have previously been in the inactive state are more likely to remain inactive, it may be necessary or desirable to also consider the previous state of each node when determining whether to perform a weight update.

FIG. 4 illustrates an example of performing a weight update or gradient accumulation based on both the previous and current states of each node. Referring to FIG. 4, if node 21 in the inactive state remains inactive in a subsequent stage, gradient accumulation may be performed (\textcircled{1}) , and if node 22 in the active state remains active in the subsequent stage, a gradient-based weight update may be performed (\textcircled{4}) , as in example embodiments illustrated in FIG. 2. However, if node 22 in the active state was previously inactive, gradient accumulation may also be performed (\textcircled{2}) even though the current state is active. Similarly, if node 21 in the inactive state was previously active, gradient accumulation may be performed (\textcircled{3}) . For example, unlike example embodiments illustrated in FIG. 3, example embodiments illustrated in FIG. 4 considers both the previous and current states of each node, resulting in more selective weight updates and further reducing communication overhead compared to the embodiment of FIG. 3.

Referring to FIG. 1, in some embodiments, the computing devices 13 may update the first weights only when the first nodes are active and the gradients of the first weights exceed a threshold. In some example embodiments, the computing devices 13 may update the first weights based on the accumulated gradients even when the first nodes are inactive, if or in response to the accumulated gradients exceeding the threshold. In this case, the threshold for the accumulated gradients may vary depending on the type of the neural network models 14 or input data. This can prevent or reduced the likelihood of and/or impact from the training of the neural network models 14 from becoming excessively slow due to gradient compression. Meanwhile, after updating the first weights based on the calculated gradients and the accumulated gradients, the computing devices 13 may initialize the accumulated gradients.

In some example embodiments where the activation function used is a ReLU, if or in response to the input data for the first nodes being negative, the first nodes may be determined to be inactive regardless of the results of the computations. Through this, only accumulation may be performed for small gradients resulting from momentum, and even if the training of the neural network models 14 is repeated, communication overhead may remain zero.

The server 11 and the computing devices 13 may be configured using one or more physical servers included in a server farm based on cloud technologies, such as virtual machines. The detailed configuration and operation of the computing devices 13 according to some example embodiments will be described later with reference to FIG. 11.

In some example embodiments, the server 11 may deploy the neural network models 14 trained according to the aforementioned embodiments to a user terminal (not illustrated). Here, the user terminal may include any one or more devices used by a user to perform tasks using the deployed neural network models 14, such as a smartphone, tablet PC, and laptop.

The components illustrated in FIG. 1 may communicate with each other through a network. For example, the network may be implemented as any type of wired and/or wireless network, such as one or more of a local area network (LAN), a wide area network (WAN), a mobile radio communication network, or a Wireless Broadband Internet (WiBro) network.

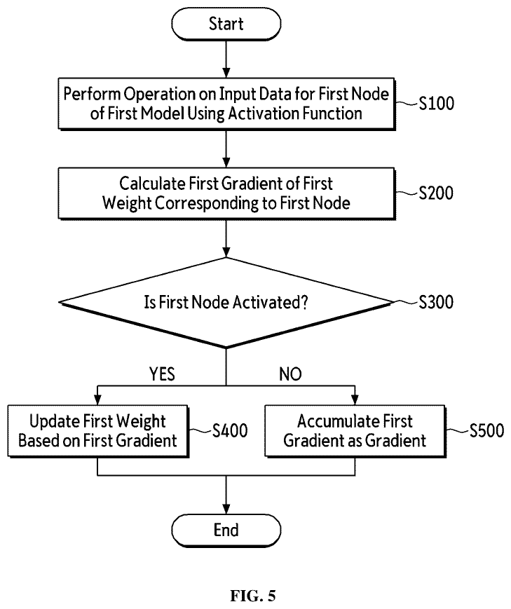

FIG. 5 is a flowchart illustrating a gradient compression method according to some example embodiments. FIG. 5 and FIGS. 6 through 8, which will be described later, illustrate steps/operations performed by the computing devices 13 in FIG. 1 or a computing device 500 in FIG. 11. Therefore, in the following description, if the subject of a specific step/operation is not explicitly mentioned, it is to be understood that the specific step/operation may be performed by the computing devices 13 in FIG. 1 and/or the computing device 500 in FIG. 11.

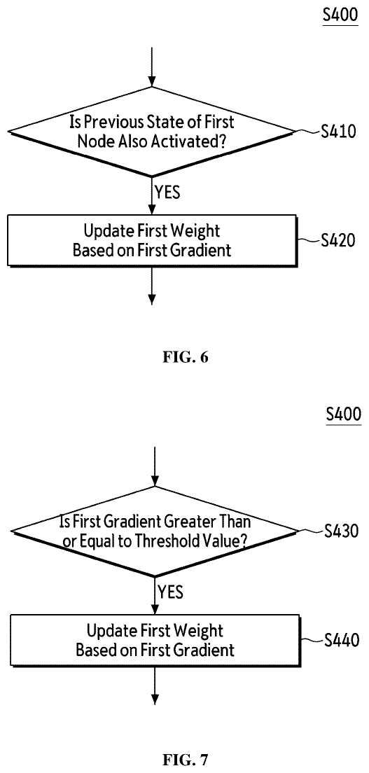

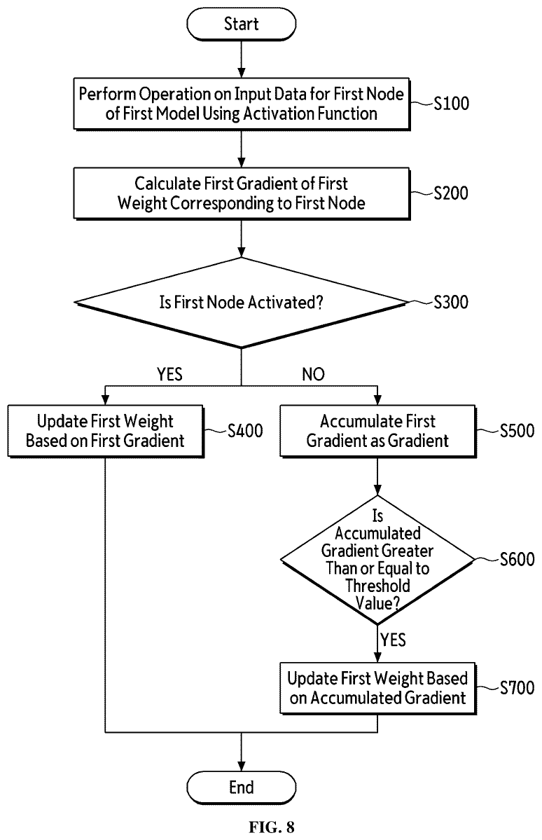

Referring to FIG. 5, in operation S100, a computation may be performed on input data for a first node of a first model using an activation function. In operation S200, based on the result of the computation, a first gradient of a first weight corresponding to the first node may be calculated. In operation S300, a determination may be made as to whether the first node is in the active state based on the result of the computation. In operation S400, if the first node is in the active state (“YES”), the first weight may be updated based on the first gradient. If an accumulated gradient for the first node already exists, the first weight may be updated based on both the accumulated gradient and the first gradient, and the accumulated gradient may be initialized after the update. Conversely, if the first node is not in the active state (“NO”), the first gradient may be accumulated as an accumulated gradient for the first node in operation S500. Examples of operation S400 will be described later with reference to FIGS. 6 and 7.

FIG. 6 is a flowchart illustrating an embodiment of operation S400 of FIG. 5, which is the step of updating the first weight. Referring to FIG. 6, in operation S410, a determination may be made as to whether the first node, currently active, was previously in the active state. If the first node was also previously active (“YES”), the first weight may be updated based on the first gradient in operation S420. The embodiment of FIG. 6 corresponds to the embodiment of FIG. 4.

FIG. 7 is a flowchart illustrating another embodiment of operation S400 of FIG. 5. Referring to FIG. 7, in operation S430, a determination may be made as to whether the first gradient exceeds a threshold. If the first gradient exceeds the threshold (“YES”), the first weight may be updated based on the first gradient in operation S440.

FIG. 8 is a flowchart illustrating a gradient compression method according to another embodiment of inventive concepts. Referring to FIG. 8, after operation S500, a determination may be made in operation S600 as to whether the accumulated gradient exceeds a threshold. If the accumulated gradient exceeds the threshold (“YES”), the first weight may be updated based on the accumulated gradient in operation S700, regardless of the state of the first node (i.e., even if the first node is in the inactive state).

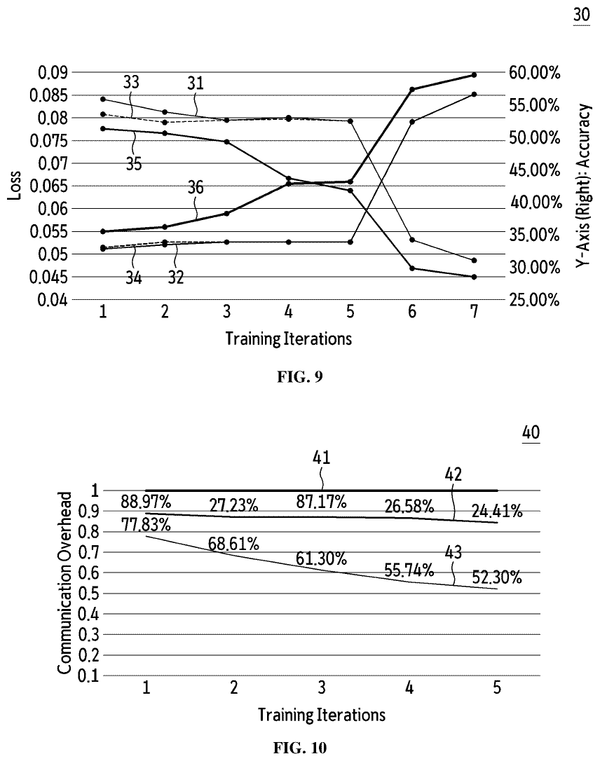

FIG. 9 shows the loss and accuracy of a neural network model according to the number of training iterations using the gradient compression methods according to some example embodiments. In graph 30, reference numeral 31 indicates the loss according to the number of training iterations when the neural network model is trained using a conventional method without gradient accumulation, reference numeral 33 indicates the loss according to the number of training iterations when the neural network model is trained using the gradient accumulation method that considers only the current state of each node, as in the embodiment of FIG. 3, and reference numeral 35 indicates the loss according to the number of training iterations when the neural network model is trained using gradient accumulation that considers both the previous and current states of each node, as in the embodiment of FIG. 4. Reference numerals 32, 34, and 36 respectively indicate the accuracy according to the number of training iterations when the neural network model is trained using the conventional method, the embodiment of FIG. 3, and some example embodiments as illustrated in FIG. 4. Referring to FIG. 9, it is confirmed that adopting the neural network model training methods according to some example embodiments results in more reduced or minimized loss and higher accuracy compared to conventional training methods.

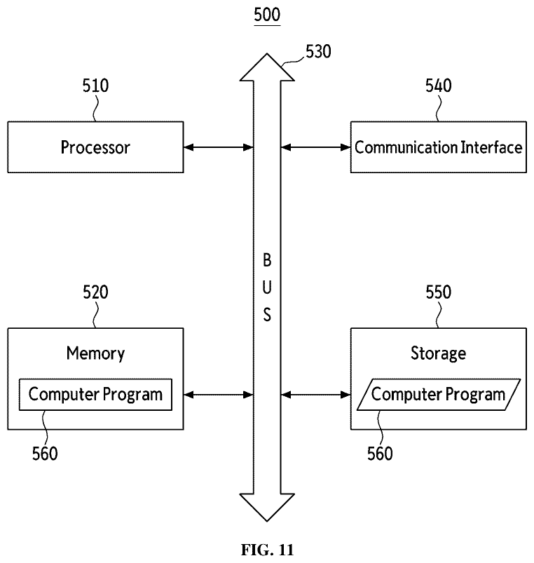

FIG. 10 shows the communication overhead according to the number of training iterations for a neural network model using the gradient compression methods according to some example embodiments. In graph 40, reference numeral 41 indicates the communication overhead according to the number of training iterations when the neural network model is trained using a conventional method, reference numeral 42 indicates the communication overhead according to the number of training iterations when the neural network model is trained using the gradient accumulation method that considers only the current state of each node, as in some example embodiments as illustrated in FIG. 3, and reference numeral 43 indicates the communication overhead according to the number of training iterations when the neural network model is trained using the gradient accumulation method that considers both the previous and current states of each node, as in some example embodiments as illustrated in FIG. 4. Referring to FIG. 10, it may be confirmed that adopting the neural network model training methods according to some example embodiments significantly reduces communication overhead compared to conventional training methods. In particular, it may be confirmed that the communication overhead is significantly reduced when the neural network model is trained according to some example embodiments as illustrated in FIG. 4 compared to when it is trained according to some example embodiments as illustrated in FIG. 3.

In summary, referring to both FIGS. 9 and 10, by training a neural network model according to some example embodiments, loss is further reduced or minimized, accuracy is further improved, and/or communication overhead is reduced.

FIG. 11 is a block diagram illustrating the hardware configuration of a computing device including a neural network model, according to some example embodiments.

Referring to FIG. 11, a computing device 500 may include at least one processor 510, a bus 530, a communication interface 540, a memory 520 for loading a computer program 560 executed by the processor 510, and a storage 550 for storing the computer program 560. However, FIG. 11 only depicts components relevant to some example embodiments. Therefore, it is to be understood that, in addition to the components illustrated in FIG. 11, other general-purpose components may also be included. For example, the computing device 500 may include various components other than those illustrated in FIG. 11. Additionally or additionally, the computing device 500 may be configured with some of the components illustrated in FIG. 11 omitted. Each component of the computing device 500 will hereinafter be described.

The processor 510 may control at least some or up to all of the overall operations of the components of the computing device 500. The processor 510 may include at least one of a central processing unit (CPU), a micro processing unit (MPU), a micro controller unit (MCU), a graphics processing unit (GPU), or any other type of processor. Additionally, the processor 510 may perform computations for at least one application or program to execute operations/methods according to some example embodiments. The computing device 500 may include one or more processors.

The memory 520 may store various data, commands, and/or information. The memory 520 may load the computer program 560 from the storage 550 to execute the operations/methods according to some example embodiments. The memory 520 may be implemented as or may include a non-volatile memory and/or a volatile memory, such as a random-access memory (RAM), but example embodiments are not limited thereto.

The bus 530 may provide communication functions between the components of the computing device 500. The bus 530 may be implemented as various types of buses, such as an address bus, a data bus, and a control bus.

The communication interface 540 may support both wired and wireless Internet communication for the computing device 500. Alternatively or additionally, the communication interface 540 may support various communication methods other than Internet communication. To this end, the communication interface 540 may include a communication module.

The storage 550 may non-transitorily store one or more computer programs 560. The storage 550 may be implemented as a non-volatile memory, such as one or more of a read-only memory (ROM), an erasable programmable ROM (EPROM), an electrically erasable programmable ROM (EEPROM), a flash memory, a hard disk, a removable disk, or any type of computer-readable recording medium.

The computer program 560 may include one or more instructions that, when loaded into the memory 520, enable the processor 510 to perform various operations/methods according to some example embodiments. In other words, by executing the loaded instructions, the processor 510 may perform the various operations/methods according to some example embodiments.

For example, the computer program 560 may include instructions for performing the operations of: performing a computation on input data for a first node of a first model using an activation function; calculating a first gradient of a first weight corresponding to the first node based on the result of the computation; determining whether the first node is in an active state based on the result of the computation; updating the first weight based on the first gradient if the first node is in the active state; and accumulating the first gradient as an accumulated gradient for the first node if the first node is in an inactive state.

According to some example embodiments, since gradients are accumulated based on both the pattern of an activation function and the activation or inactivation of nodes in each neural network model, without needing to or expecting to determine a threshold for the accumulated gradients whenever each neural network model or training dataset changes, communication overhead can be reduced without degrading the efficiency of training each neural network model. Alternatively or additionally, as communication overhead decreases, the power consumption of a parameter server and hardware devices may also significantly decrease.

Various example embodiments and the effects according to those example embodiments have been mentioned above with reference to the figures. The effects according to the technical idea of inventive concepts are not limited to the effects as mentioned above, and other effects not mentioned may be clearly understood by those of ordinary skill in the art from the above descriptions.

All the components that constitute the example embodiments are described as being combined with each other or operating in combination with each other. However, inventive concepts are not necessarily limited to any embodiment. In other words, within the scope of the purpose of inventive concepts, all of the components may operate in a selective combination manner of at least two thereof with each other.

Although the operations are shown as being executed in a specific order in the drawings, it should not be understood that the operations should be performed in the specific order as shown or in a sequential order or that all illustrated operations should be performed to obtain the desired result.

The computing devices may, for example, have a structure that is trainable, e.g., with training data, such as an artificial neural network, a decision tree, a support vector machine, a Bayesian network, a genetic algorithm, and/or the like. Non-limiting examples of the trainable structure may include a convolution neural network (CNN), a generative adversarial network (GAN), an artificial neural network (ANN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Although some example embodiments have been described with reference to the accompanying drawings, example embodiments are not limited to the above embodiments, but may be implemented in various different forms. A person of ordinary skill in the art may appreciate that example embodiments may be practiced in other concrete forms without changing the technical spirit or essential characteristics of the described example embodiments. Therefore, it should be appreciated that example embodiments as described above is not restrictive but illustrative in all respects. Additionally example embodiments are not necessarily mutually exclusive with one another. For example, some example embodiments may include one or more features described with reference to one or more figures, and may also include one or more other feature described with reference to one or more other figures.

What is claimed is:

1. A gradient compression method performed by a computing device, the gradient compression method comprising:
performing a computation on input data for a first node of a first model using an activation function;
calculating a first gradient of a first weight corresponding to the first node based on a result of the computation;
determining whether the first node is in an active state based on a result of the computation;
updating the first weight based on the first gradient in response to the first node being in the active state; and
accumulating the first gradient as an accumulated gradient for the first node in response to the first node not being in the active state.

2. The gradient compression method of claim 1, wherein the updating the first weight comprises updating the first weight based on the first gradient and on the accumulated gradient.

3. The gradient compression method of claim 1, wherein the updating the first weight comprises updating the first weight based on the first gradient in response to a previous state and a current state of the first node both being the active state.

4. The gradient compression method of claim 1, wherein the updating the first weight comprises updating the first weight based on the first gradient in response to the first gradient exceeding a threshold.

5. The gradient compression method of claim 1, wherein
the activation function is based on a rectified linear unit (ReLU), and
the first model is based on an image classification model.

6. The gradient compression method of claim 5, wherein
the input data is a negative value, and
the determining whether the first node is in the active state comprises determining that the first node is not in the active state regardless of the result of the computation.

7. The gradient compression method of claim 1, wherein the updating the first weight further comprises initializing the accumulated gradient after the first weight is updated.

8. The gradient compression method of claim 1, further comprising:
updating the first weight based on the accumulated gradient regardless of whether the first node is in the active state, in response to the accumulated gradient exceeding a threshold.

9. A gradient compression system comprising:
a processor; and
a non-transitory computer-readable memory storing instructions that, when executed by the processor, cause the system to:
perform a computation on input data for a first node of a first model using an activation function;
calculate a first gradient of a first weight corresponding to the first node based on a result of the computation;
determine whether the first node is in an active state based on the result of the computation;
update the first weight based on the first gradient in response to the first node being in the active state; and
accumulate the first gradient as an accumulated gradient for the first node in response to the first node not being in the active state.

10. The gradient compression system of claim 9, wherein the updating the first weight comprises updating the first weight based on the first gradient and on the accumulated gradient.

11. The gradient compression system of claim 9, wherein the updating the first weight comprises updating the first weight based on the first gradient in response to a previous state and a current state of the first node both being the active state.

12. The gradient compression system of claim 9, wherein the updating the first weight comprises updating the first weight based on the first gradient in response to the first gradient exceeding a threshold.

13. The gradient compression system of claim 9, wherein the updating the first weight further comprises initializing the accumulated gradient after the first weight is updated.

14. The gradient compression system of claim 9, wherein in response to the accumulated gradient exceeding a threshold, upon being executed by the processor, the instructions enable the system to further update the first weight based on the accumulated gradient, regardless of whether the first node is in the active state.

15. A non-transitory computer-readable medium storing a computer program,
the computer program configured to, when executed by a processor, cause the processor to:
perform a computation on input data for a first node of a first model using an activation function; calculate a first gradient of a first weight corresponding to the first node based on a result of the computation;
determine whether the first node is in an active state based on the result of the computation; update the first weight based on the first gradient if the first node is in the active state;
and accumulate the first gradient as an accumulated gradient for the first node in response to the first node not being in the active state.

16. The non-transitory computer-readable medium of claim 15, wherein the updating the first weight comprises updating the first weight based on the first gradient and the accumulated gradient.

17. The non-transitory computer-readable medium of claim 15, wherein the updating the first weight comprises updating the first weight based on the first gradient in response to a previous state and a current state of the first node both being the active state.

18. The non-transitory computer-readable medium of claim 15, wherein the updating the first weight comprises updating the first weight based on the first gradient in response to the first gradient exceeding a threshold.

19. The gradient compression system of claim 9, wherein the updating the first weight further comprises initializing the accumulated gradient after the first weight is updated.

20. The non-transitory computer-readable medium of claim 15, wherein in response the accumulated gradient exceeds a threshold, the computer program configured to, upon being executed by the processor, further cause the processor to update the first weight based on the accumulated gradient, regardless of whether the first node is in the active state.
